(19) United States
(12) Patent Application Publication
(10) Pub. No.: US 2004/0194135 A1
(43) Pub. Date: Sep. 30, 2004

(54) Method, system, and apparatus for customizing television channel lists

(76) Inventor: Michael Kahn, Westampton, NJ (US)

Correspondence Address: RATNERPRESTIA, P O BOX 980, VALLEY FORGE, PA, 19482-0980, US

(21) Appl. No.: 10/403,336

(22) Filed: Mar. 31, 2003

(51) Int. Cl. H04N 5/44; H04N 5/50; G06F 13/00; H04N 7/00; H04N 5/445; G06F 3/00

(52) U.S. Cl. 725/38; 348/731; 348/734; 725/37; 725/52

(57) ABSTRACT

Methods, systems, and apparatus to customize television channel lists are disclosed. The television channel lists are updated by adding/deleting ranges of channels from the channel list where the channel ranges are defined by a user.

### FIELD OF THE INVENTION

The present invention relates to the field of television electronics and, more particularly, to customizing television channel selection lists.

### BACKGROUND OF THE INVENTION

Presently, many television service providers offer hundreds of television channels to their viewers. Set top boxes are available that display a list of the available channels and programming on the respective channels to assist viewers in identifying programs that they want to view. Due to the large number of available channels, these set top boxes frequently permit the viewer to create a customized list of desired channels to facilitate the viewer's identification of desired programming.

Existing methods of creating customized channel lists involve adding/deleting one channel at a time, which is inconvenient if the viewer wants to add/delete a large number of channels. There is a large demand for television features that offer added convenience to viewers. Accordingly, more convenient methods, systems, and apparatus for customizing channel lists are needed. The present invention fulfills this need among others.

### SUMMARY OF THE INVENTION

The present invention provides methods, systems, and apparatus for customizing television channel lists. Customization of the television channel lists is accomplished by enabling a user to define ranges of channels for inclusion in the television channel lists. The user defined channel ranges allow the addition/deletion of a large number of channels quickly and easily to/from a television channel list. Accordingly, the present invention offers added convenience in the creation of customized television channel lists.

A method in accordance with the present invention includes receiving a first channel indicator corresponding to a first channel and a second channel indicator corresponding to a second channel, the first and second channels defining a range of television channels, and selectively updating a customized channel list with respect to inclusion of the range of television channels responsive to the received first and second channel indicators.

A system in accordance with the present invention includes means for receiving a first channel indicator corresponding to a first channel and a second channel indicator corresponding to a second channel, the first and second channels defining a range of television channels, and means for selectively updating a customized channel list with respect to inclusion of the range of television channels responsive to the received first and second channel indicators.

An apparatus in accordance with the present invention includes a processor and a display circuit. The processor generates a graphical user interface to solicit a first and second channel from a user, the first and second channels defining a range of television channels; receives a first channel indicator corresponding to the first channel and a second channel indicator corresponding to the second channel; and selectively updates a customized channel list with respect to inclusion of the range of television channels responsive to the received first and second channel indicators. The display circuit displays the graphical user interface generated by the processor.

### BRIEF DESCRIPTION OF THE DRAWINGS

The invention is best understood from the following detailed description when read in connection with the accompanying drawings. Included in the drawings are the following features:

FIG. 1 is a block diagram of an exemplary channel selection system in which certain aspects of the present invention may be performed;

FIG. 2 is a flow chart depicting exemplary steps for customizing a channel selection list in accordance with the present invention;

FIG. 3 is an exemplary graphical user interface for soliciting information from a user in accordance with certain aspects of the present invention; and

FIG. 4 is an alternative exemplary graphical user interface for soliciting information from a user in accordance with certain other aspects of the present invention.

### DETAILED DESCRIPTION OF THE INVENTION

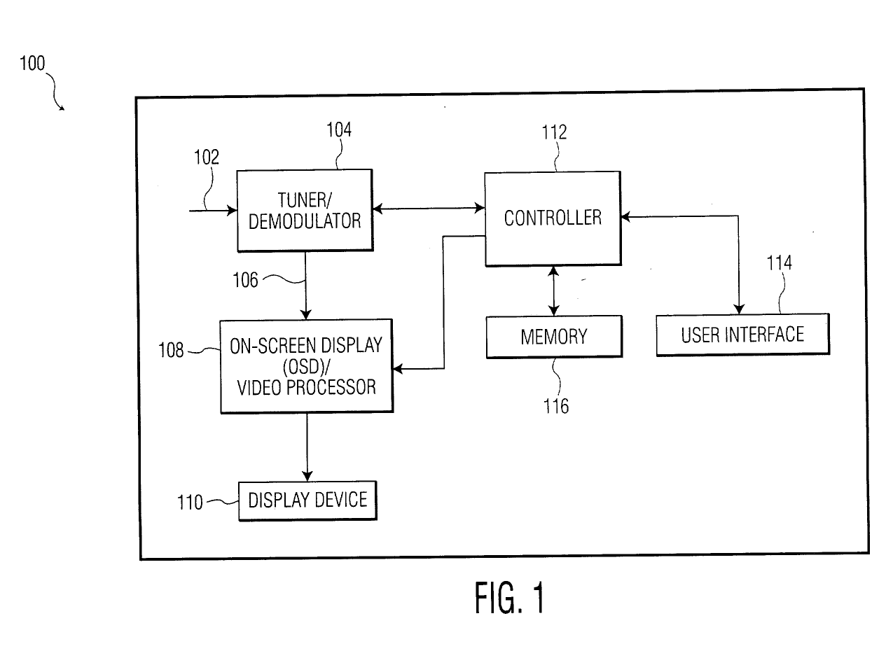

FIG. 1 depicts an exemplary embodiment of a channel selection system 100 in accordance with the present invention. In the exemplary embodiment of the invention, a digital or analog television signal 102 is applied to a tuner/demodulator 104. The tuner/demodulator 104 tunes and demodulates the television signal 102 to yield a demodulated television signal 106. The demodulated television signal 106 is provided to an on-screen display (OSD)/video processor 108 for display on a display device 110 such as a television monitor. In an exemplary embodiment, a channel list of all available channels is further provided through the television signal 102. In accordance with this embodiment, the tuner/demodulator 104 separates the channel list from the demodulated television signal 106 and provides the channel list to a controller 112.

The controller 112 controls the tuner/demodulator 104 and the OSD/video processor 108. In an exemplary embodiment, the controller 112 receives a channel list of available channels from the tuner/demodulator 104. In an alternative exemplary embodiment, the controller 112 cycles the tuner/demodulator 104 throughout the entire operating frequency range of the tuner/demodulator 104 to identify all channels that the tuner/demodulator 104 is capable of tuning and creates a channel list from the identified channels. In an exemplary embodiment of the present invention, the controller 112 is configured to produce a customized channel list selected from the available channels. In accordance with this embodiment, the controller 112 is responsive to instructions from a user that identifies the channels to include in the customized channel list, which the user provides through a user interface 114. A suitable controller 112 for use in the present invention will be readily apparent to those of skill in the art of television signal processing.

A user provides instruction signals to the controller 112 through the user interface 114. It is contemplated that the user interface 114 may include a wireless interface, such as infrared (IR) or radio frequency (RF), for communication with a wireless device such as a remote control (not shown). Through the user interface 114, the user selects programs for viewing and customizes a channel selection list in accordance with an exemplary embodiment of the present invention.

A memory 116 stores information for the controller 112. In an exemplary embodiment, a list of all channels available from a service provider and one or more custom channel lists are stored in the memory 116. A suitable memory for use in the present invention will be readily apparent to those of skill in the art of television signal processing.

It is contemplated that the system 100 may be implemented in an integrated receiver/decoder (IRD) contained within a display device 110 (e.g. a television) or part of a set-top box (not shown), which may contain additional circuitry. The OSD/television signal processor 108 may be a conventional analog television signal processing system including circuits for decoding and processing both audio and video components and coupled to a conventional OSD processor.

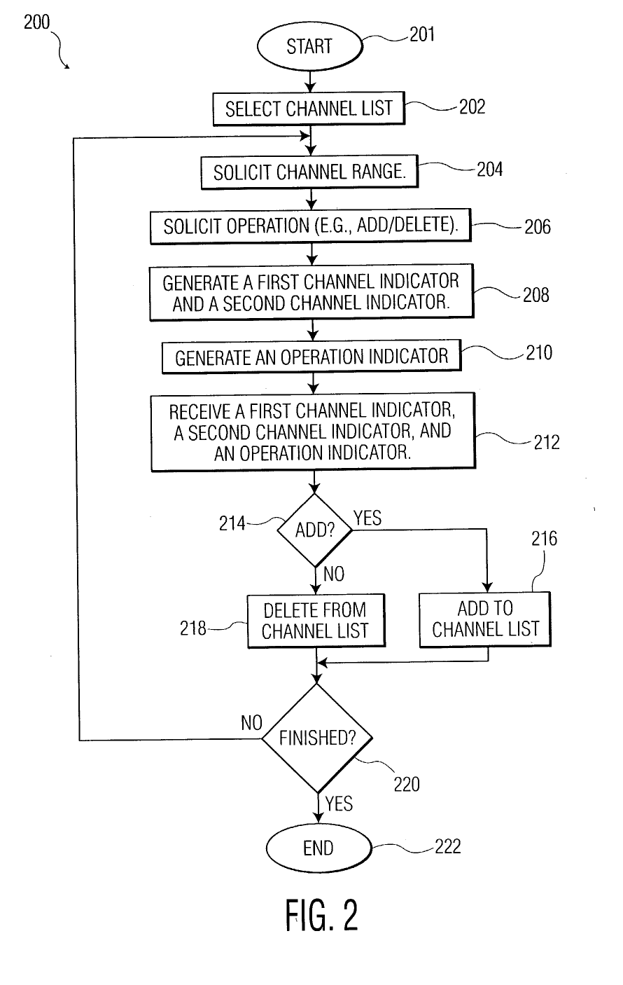

FIG. 2 depicts a flow chart 200 of exemplary steps for customizing a channel selection list in accordance with the present invention. In an exemplary embodiment, processing begins at block 201 when a customization option is selected by a user via a user interface 114 (FIG. 1), e.g., using a remote control (not shown). The remote control may contain a “channel list” button that, when depressed, prompts a controller 112 (FIG. 1) to instruct an OSD/video processor 108 (FIG. 1) to display a channel list menu screen (not shown) on a display device 110 (FIG. 1).

At block 202, a channel list is selected. In an exemplary embodiment, the channel list is selected from one or more lists on a channel list menu screen. For example, the channel list menu screen may contain a channel list button associated with all available channels, a first custom channel list button associated with a first custom channel list, and a second channel list button associated with a second custom channel list. A user can select the desired channel list in a conventional manner via the user interface 114. For example, the user can select the first custom channel list for updating by selecting the first custom channel list button with the remote control device.

At block 204, a channel range is solicited from a user. Thus, the channel range is user definable. In an exemplary embodiment, the channel range is defined by a starting channel (or first channel) and an ending channel (or second channel), and includes those channels and the channels therebetween. In an exemplary embodiment, the first and second channels define a range of channels including only channels containing programming. For example, if channels 63 and 85 are not in use by the television signal provider, adding channels between 1 and 99 would include channels 1-62, 64-84, and 86-99, but not channels 63 and 85. In addition, in certain exemplary embodiments, if a certain channels has multiple subchannels with programming, all subchannels with programming are added when the channel containing those subchannels is within the added range.

At block 206, an operation is solicited. In an exemplary embodiment the solicited operation is either add or delete. As described in detail below, in an exemplary embodiment, the add operation causes the addition of the channel range solicited at block 204 to the channel list selected at block 202 and the delete operation causes the deletion of the solicited channel range from the selected channel list.

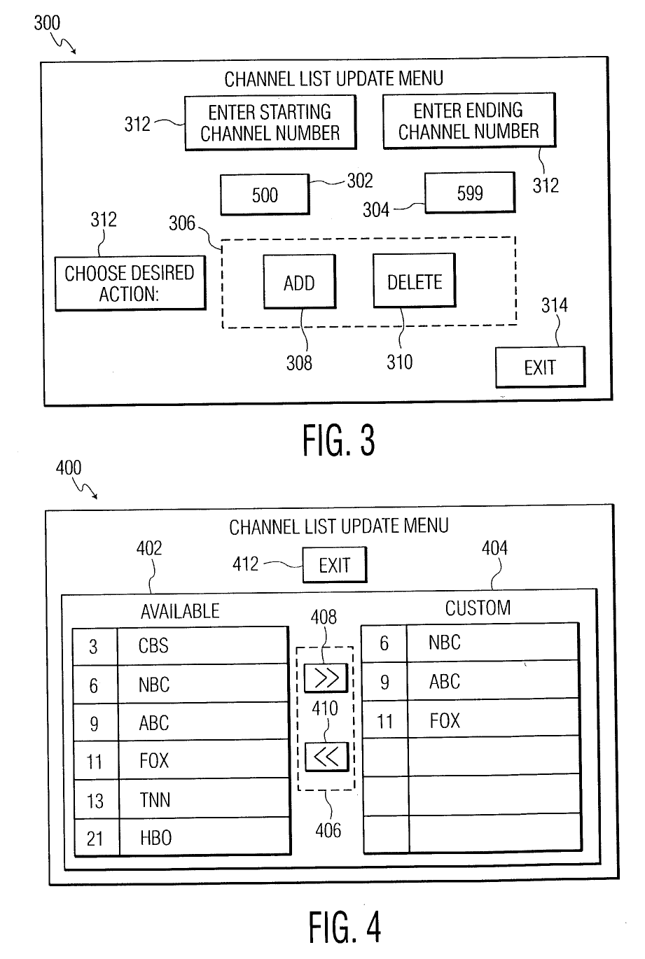

In an exemplary embodiment, the channel range and operation in the steps of block 204 and 206, respectively, are solicited from the user via a graphical user interface (GUI) channel list update menu displayed on a display device 110 (FIG. 1). In certain exemplary embodiments, the channel list menu screen, described above with reference to the selection of a channel list at block 202, contains an update button that, when selected, results in the display of a channel list update menu such as depicted in FIGS. 3 and 4.

FIG. 3 depicts an exemplary embodiment of a channel list update menu 300. The exemplary menu 300 includes a starting (or first) channel number input box 302, an ending (or second) channel number input box 304, and an operation selection box 306. In the illustrated embodiment, the operation selection box 306 includes an add operation indicator button 308 and a delete operation indicator button 310. In addition, the illustrated channel list update menu 300 includes text boxes 312 for instructing a user that is interfacing with the channel list update menu 300, and an “EXIT” button 314.

In an exemplary embodiments, a user specifies a range of channels to add to/delete from a custom channel list by entering a first channel at one end of the range in the first channel number input box 302 and a second channel at the other end of the range in the second channel number input box 304. The user can add the selected range to the selected channel list by selecting the add operation indicator button 308. The user can delete the selected range from the selected channel list by selecting the delete operation indicator button 310. For example, to add channels 500 to 599 to the custom channel list, a user enters the numeral 500 in the first channel number input box 302, the numeral 599 in the second channel number input box 304, and selects the add channel indicator button 308. To delete channels 500 to 599 from the custom channel list, the user enters the numeral 500 in the first channel selection box 302, the numeral 599 in the second channel selection box 304, and selects the delete channel indicator button 310.

FIG. 4 depicts an alternative exemplary embodiment of a channel list update menu 400. The exemplary menu 400 includes an available channel list 402, a custom channel list 404 corresponding to the channel list selected at block 202, and operation selection box 406. In the illustrated embodiment, the operation selection box 406 includes an add operation indicator button 408 and a delete operation indicator button 410. In addition, the illustrated channel list update menu 300 includes an “EXIT” button 412. In an exemplary embodiment, the available channel list 402 includes all available channels from a service provider, including channels in the custom channel list 404. In alternative exemplary embodiments, when channels are added to the custom channel list 404, they are removed from the available channel list 402. In an exemplary embodiment, the content within the available channel list 402 and the custom channel list 404 are stored in a memory 116 (FIG. 1) for retrieval and updating by the controller 112 (FIG. 1) as needed.

In an exemplary embodiments, a user specifies a certain range of channels to add to the custom channel list 404 by selecting in a known manner from the available channel list 402 a first channel at one end of a desired channel range and a second channel at the other end of the range. For example, the user may enter the first channel and the second channel using a key pad of the remote control, with a left/right arrow of the remote control used to alternate between the first channel selection and the second channel selection. Alternatively, the user may enter the first channel using a keypad of the remote control and then press up/down arrows on the remote control one or more times to select a second channel that is a number of channels above/below the first channel. Various alternative methods for selecting the first and second channels will be apparent to those of skill in the art from the above examples, and are considered within the scope of the present invention. In certain exemplary embodiments, once selected, the channel range is shaded to indicate the selected channels within the range.

To add the range of channels to the custom channel list 404, the user can perform a known “drag and drop” function to move the selected range from the available channel list 402 to the custom channel list 404 or can select the add operation indicator button 408. Likewise, a user may specify a certain range of channels to delete from the custom channel list 404 by selecting the range from the custom channel list 404 and either drag and dropping the range from the custom channel list 404 to the available channel list 402 or selecting the delete operation indicator button 410. For example, to add channels 6, 9, and 11 to the custom channel list 404, a user selects channels 6 and 11 from the available channel list 402. After the second channel is selected (e.g., channel 11), channels 6, 9, and 11 are automatically highlighted (e.g., are shaded). Channels 6, 9, and 11 are then dragged from the available channel list 402 and dropped in the custom channel list 404 (or the add channel button 408 is selected). To delete channels 6, 9, and 11 from the custom channel list 404, a user selects channels 6 and 11 from the custom channel list 404. After the second channel is selected (e.g., channel 11), channels 6, 9, and 11 are automatically highlighted (e.g., are shaded). Channels 6, 9, and 11 are then dragged from the current channel list 404 and dropped in the available channel list 402 (or the delete channel indicator button 410 is selected).

Referring back to FIG. 2, at block 208, a first channel indicator and a second channel indicator are generated. In an exemplary embodiment, the first and second channel indicators are generated in response to the entry of solicited information at blocks 204 and 206. For example, referring to FIG. 3, the first channel indicator and the second channel indicator may be generated from channel numbers input in the first and second channel number input boxes 302, 304, respectively, in response to the selection of one of the operation indicator buttons 308, 310. Likewise, referring to FIG. 4, the first and second channel indicators may be generated from the first and last channels in the available channel list 402 when one of the operation indicator buttons 408, 410 is selected. In addition, further referring to FIG. 4, the first and second channel indicators may be generated from the first and last selected channels in the available channel list 402 when the channel range defined by those channels are dragged and dropped in the custom channel list 404.

At block 210, an operation indicator is generated. In an exemplary embodiment, the operation indicator is generated when a user selects a corresponding operation indicator button on a graphical user interface, e.g., the operation indicator buttons 308, 310 of FIG. 3 or the operation indicator buttons 408, 410 of FIG. 4. In an alternative exemplary embodiment, the operation indicator is generated automatically in response to the actions of a user. For example, referring to FIG. 4, an add operation indicator is automatically generated when dragging a selected range of channels from the available channel list 402 to the custom channel list 404 and a delete operation indicator is automatically generated when dragging a selected range of channels from the custom channel list 404 to the available channel list 402.

At block 212, a first channel indicator, a second channel indicator, and an operation indicator are received. In an exemplary embodiment, the indicators are received at the controller 112 (FIG. 1) for processing. In certain exemplary embodiments, the operation indicators are generated internally by the controller 112 in response to the actions of a user as described above with reference to block 210 and, thus, are considered received by the controller 112 from the controller 112.

At block 214, a decision is performed based on the operation indicator received at block 212. In an exemplary embodiment, the controller 112 (FIG. 1) compares the operation indicator to an add operation indicator. In the exemplary embodiment, if the operation indication received at block 212 is an add operation indicator, processing proceeds at block 216. Otherwise, processing proceeds at block 218.

At block 216, the channel range defined by the first channel and the second channel, solicited at block 206, is added to the channel list selected at block 202. At block 218, the channel range defined by the first channel and the second channel solicited at block 206 is deleted from the channel list selected at block 202. In an exemplary embodiment, the channel list selected at block 202 is updated in a known manner and the resultant updated channel list is stored in a memory, e.g., memory 116 (FIG. 1), to replace the previous custom channel list.

At block 220, a decision is performed to determine if the update of the selected channel list is complete. If the update is complete, processing ends at block 222. If the update is not complete, processing proceeds at block 204, and the steps in blocks 204-218 are repeated. In an exemplary embodiment, the update is complete when a user selects an indicator such as an “EXIT” button of a channel list update menu, e.g., using a remote control. In certain other exemplary embodiments, the update is complete when a user selects a button on a remote control, e.g., the channel list button that invoked the steps of the flow chart at block 201.

It will be appreciated that the steps described above with reference flow chart 200 may vary widely according to desired implementation.

In an exemplary use, the present invention can be used to quickly and easily add/delete television channels within a user defined range to/from a custom television channel list. This present invention may be used to add/delete grouped channels having a particular theme to/from the custom television channel list. Typically, satellite and cable television providers group channels in ranges by certain themes. Table 1 depicts exemplary themes for available channels ranging from channel 0 to channel 599.

TABLE 1

| Channel Numbers | Theme |
|---|---|
| 0-99 | Local Channels |
| 100-199 | Pay Per View Channels |
| 200-299 | Cable Network Channels |
| 300-350 | Music channels |
| 351-400 | News Channels |
| 401-499 | Movie Channels |
| 500-550 | Adult Channels |
| 551-599 | Sports Channels |

If channels are grouped as depicted in TABLE 1, a user can quickly and easily add all channels of a particular theme, e.g., news channel, to the custom channel list using the channel list update menu of FIG. 3 by entering channel 351 as a starting channel number, entering channel 400 as an ending channel number, and selecting the add operation button 308. In addition, a user can quickly and easily remove all channels of a particular theme, e.g.,adult channels, which were previously placed in the custom channel list, by entering channel 500 as the starting channel number, entering channel 550 as the ending channel number, and selecting the delete operation button 310. In certain exemplary embodiments, sub-ranges of channels or individual channels may be added/deleted after a range of channels that have been added/deleted in order to further customize a list. In certain exemplary embodiment, if a range of added channels includes a channel already on the list to which the channels are being added, the current channel in the list is overwritten.

Although the invention has been described in terms of soliciting information from a user with a GUI, alternative information solicitation methods may be employed such as the use of audio commands. For example, the user may hear “Enter the starting program number,” followed by a pause in which the user enters a channel number using a remote control or through a verbal response interpreted by a user interface 114 (FIG. 1). In an alternative embodiment, information is solicited by following directions in a printed guide, e.g., the owner's manual. In accordance with this embodiment, the user may be instructed to depress a custom channel list button, or specified sequence of keys, to enter a customization routine. The user may then be instructed to enter a first channel number followed by an up/down arrow and a second number followed by a left/right arrow (where the left arrow is an indicator to deleting the selected range from the custom channel list and a right arrow is an indicator to add the selected range to the custom channel list). Various alternative embodiments for soliciting information from a user will be readily apparent to those of skill in the art from the above description.

Although the invention has been described in terms of a tuner/demodulator 104, an OSD display/video processor 108, and a controller 112 for updating a custom television channel list, it is contemplated that the invention may be implemented in software on a general purpose computer. In this embodiment, one or more of the functions of the various components may be implemented in software that controls the general purpose computer. This software may be embodied in a computer readable carrier, for example, a magnetic or optical disk, a memory-card or an audio frequency, radio-frequency, or optical carrier wave.

Although the invention has been described in terms of an exemplary embodiment, it is contemplated that it may be practiced as described above with variations within the knowledge and skill of a person ordinarily skilled in the art and within the scope of the appended claims.

What is claimed:

1. A method for customizing a television channel list comprising the steps of:
receiving a first channel indicator corresponding to a first channel and a second channel indicator corresponding to a second channel, the first and second channels defining a range of television channels; and
selectively updating a customized channel list with respect to inclusion of the range of television channels responsive to the received first and second channel indicators.

2. The method of claim 1, further comprising the step of:
receiving an operation indicator representing actions related to inclusion of the range of television channels in the customized channel list;
wherein the step of selectively updating the customized channel list is further responsive the operation indicator.

3. The method of claim 2, wherein the operation indicator is an add indicator or a delete indicator and wherein the selectively updating step comprises at least the steps of:
adding the range of television channels to the customized channel list if the operation indicator is the add indicator; and
removing the range of television channels from the customized channel list if the operation indicator is the delete indicator.

4. The method of claim 2, wherein the operation indicator is selected by a user.

5. The method of claim 2, wherein the operation indicator is automatically selected responsive to a user action.

6. The method of claim 1, further comprising the steps of:
soliciting the first and second channels from a user; and
generating the first and second channel indicators responsive to the solicited first and second channels, respectively.

7. The method of claim 6, wherein the soliciting step comprises at least the steps of:
displaying a graphical user interface having a channel range selection area for receiving the first and second channels from a user, wherein the first and second channel indicators are generated responsive to the first and second channels received from the user.

8. The method of claim 6, wherein the soliciting step comprises at least the steps of:
displaying a graphical user interface depicting a plurality of available television channels; and
enabling the selection of the first channel and the second channel from the plurality of depicted available television channels graphically through a user interface, wherein the first and second channel indicators are generated responsive of the first and second channels selected by the user.

9. A system for customizing a television channel list comprising:
means for receiving a first channel indicator corresponding to a first channel and a second channel indicator corresponding to a second channel, the first and second channels defining a range of television channels; and
means for selectively updating a customized channel list with respect to inclusion of the range of television channels responsive to the received first and second channel indicators.

10. The system of claim 9, further comprising:
means for receiving an operation indicator representing actions related to inclusion of the range of television channels in the customized channel list;
wherein the means for selectively updating the customized channel list is further responsive the operation indicator.

11. The system of claim 10, wherein the operation indicator is an add indicator or a delete indicator and wherein the selectively updating means comprises at least:
means for adding the range of television channels to the customized channel list if the operation indicator is the add indicator; and
means for removing the range of television channels from the customized channel list if the operation indicator is the delete indicator.

12. The system of claim 9 further comprising
means for soliciting the first and second channels from a user; and
means for generating the first and second channel indicators responsive to the solicited first and second channels, respectively

13. A television system having a customized channel selection list comprising:
a processor that generates a graphical user interface to solicit a first and second channel from a user, the first and second channels defining a range of television channels; receives a first channel indicator corresponding to the first channel and a second channel indicator corresponding to the second channel; and selectively updates a customized channel list with respect to inclusion of the range of television channels responsive to the received first and second channel indicators; and
a display device that displays the graphical user interface generated by the processor.

14. The system of claim 13, wherein the processor further receives an operation indicator representing actions related to inclusion of the range of television channels in the customized channel list, wherein the processor selectively updates the customized channel list further responsive to the operation indicator.

15. A television apparatus for customizing a channel selection list for use with a television, the apparatus comprising:
a processor that generates a graphical user interface to solicit a first and second channel from a user, the first and second channels defining a range of television channels; receives a first channel indicator corresponding to the first channel and a second channel indicator corresponding to the second channel; and selectively updates a customized channel list with respect to inclusion of the range of television channels responsive to the received first and second channel indicators; and
a display circuit that produces the graphical user interface for display on the television.

16. The apparatus of claim 15, wherein the processor further receives an operation indicator representing actions related to inclusion of the range of television channels in the customized channel list, wherein the processor selectively updates the customized channel list further responsive to the operation indicator.

17. A computer readable medium including software that is configured to control a general purpose computer to implement a method for customizing a television channel list, the method comprising the steps of:
receiving a first channel indicator corresponding to a first channel and a second channel indicator corresponding to a second channel, the first and second channels defining a range of television channels; and
selectively updating a customized channel list with respect to inclusion of the range of television channels responsive to the received first and second channel indicators.

18. The computer readable medium of claim 17, wherein the method implemented in software to control the general purpose computer further comprises the step of:
receiving an operation indicator representing actions related to inclusion of the range of television channels in the customized channel list;
wherein the selectively updating step of the method implemented in software to control the general purpose computer is further responsive the operation indicator.

19. The computer readable medium of claim 18, wherein the operation indicator is an add indicator or a delete indicator and the selectively updating step of the method implemented in software to control the general purpose computer comprises at least the steps of:
adding the range of television channels to the customized channel list if the operation indicator is the add indicator; and
removing the range of television channels from the customized channel list if the operation indicator is the delete indicator.

20. The computer readable medium of claim 17, wherein the method implemented in software to control the general purpose computer further comprises the steps of:
soliciting the first and second channels from a user; and
generating the first and second channel indicators responsive to the solicited first and second channels, respectively.
